(19) United States
(12) Patent Application Publication
(10) Pub. No.: US 2004/0108340 A1
(43) Pub. Date: Jun. 10, 2004

(54) Floating vent fluid dispensing spout

(76) Inventor: Daniel Dale Witt, Chilton, WI (US)

Correspondence Address: Dan Witt, 51 Baldwin St., Chilton, WI, 53014, US

(21) Appl. No.: 10/668,017

(22) Filed: Sep. 23, 2003

Related U.S. Application Data
(60) Provisional application No. 60/416,772, filed on Oct. 8, 2002.

(51) Int. Cl. B67D 5/60

(52) U.S. Cl. 222/464.3; 222/464.6; 222/479; 222/481.5

(57) ABSTRACT

A spout affixed to a fluid-dispensing container that allows unobstructed fluid flow until the spout end becomes immersed. The anti-spill and self-venting features are achieved by establishing an airway from the top of the spout and extending into the container in the form of a flexible tube. A float attached to the tube lifts the end to the surface of the fluid within the container. As fluid exits, air enters the container allowing for smooth fluid discharge. When the spout end becomes immersed, fluid is drawn into the vent instead of air. An air vacuum develops that is equal to fluid pressure within the container. Fluid flow is interrupted until the container is returned to an upright position. This allows for fluid to evacuate from the floating vent and back into the contained. The self-venting feature of the spout is then reestablished.

### CROSS-REFERENCE

Provisional Application No. 60/416,772 Filing Date Oct. 0, 2002

### FEDERALLY SPONSORED RESEARCH

“Not Applicable”

### COMPACT DISK APPENDIX

“Not Applicable”

### BACKGROUND OF INVENTION

1. Field of Invention

This invention relates to common spouts that affix to containers that dispense fluids. The most common application relates to containers used to dispense fuel but the floating vent spout can be applied to dispense a wide variety of other fluids.

One purpose of the invention is to combine the dispensing spout with the vent and thus eliminate the need for a separate venting orifice. A typical container design includes a spout of varying designs and a separate vent. The spout and vent each require separate caps to prevent spillage when the container is not in use. The user must remove both caps, the container is tilted, fluid exits through the spout and air enters the container through the vent.

A common weakness with this fluid dispensing systems relates to the potential for spillage through the vent. If the container is tilted to far, fluid can exit the vent.

The second purpose of my invention is to limit the risk of over-filling the receiving container. Many common spout designs focus on a means to direct fluid flow into a receiving container. In many cases, these spouts will continue to discharge fluid for the duration of time that the dispensing container is tilted. The user must determine when the receiving container is sufficiently filled and return the dispensing container to the upright position to stop the fluid flow. If the user doesn't accurately detect when the receiving container is full, spillage occurs. This is a significant issue when dispensing hazardous fluids such as gasoline.

2. Description of Prior Art

Other self-venting spout systems exist. The designs vary but they all share a common feature in that the vent is stationary. U.S. Pat. No. 6,401,986 incorporates the vent into the seal around the spout base. U.S. Pat. No. 6,318,604 incorporates a vent that extends through the spout side. Other designs incorporate a vent tube that is equal to the spout length. With all these and other self-venting spouts, air enters through a fixed point in the container or spout. The efficiency of any venting systems is dependent on the vent maintaining contact with the air pocket within the container. The size and orientation of the air pocket is directly related to the fluid level and tilt of the container. As fluid is being dispensed, these two variables are in a constant state of change. All spout designs that utilize a stationary venting system lack the ability to establish and maintain an unobstructed airway between the outside of the container and air pocket. Air enters at a fixed point that typically terminates at the base of the spout. Venting air travels through the fluid in the form of bubbles in order to reach the air pocket within the container. The floating-vent system provides for an unobstructed air path between the fluid discharge opening in the spout and air pocket within the container. This results in an improved flow rate through the spout.

Other anti-spill spout systems exist. The designs very but they typically incorporate a mechanical shut-off system to inhibit fluid discharge after the spout is removed from a filled receiving container. U.S. Pat. No. 6,227,419 incorporates a spring-loaded shut-off systems that requires the user to force a portion of the spout body against the opening in the receiving container. Fluid flow begins when sufficient force is applied to the spout in order to open the normally closed valve. The valve closes upon removal from the filled container. A weakness in this and other similar designs relates to the filling of fuel tanks on small hand held gasoline powered equipment. When filling string trimmers, chain saws, leaf blowers, etc the user must hold the tool with sufficient force to counteract the force necessary to open the spout. The floating vent system offers an anti-spill feature that doesn't require the user to manipulate a mechanical valve.

Floating vents are used in other fluid dispensing applications. U.S. Pat. Nos. 2,986,310 and 4,722,463 utilize the components, in conjunction with a dispensing valve, to control fluid flow from a container. Both of these designs depend on mechanical components in the nozzle to control fluid flow. My design significantly differs in that mechanical components are not needed to achieve an anti-spill feature. Furthermore, neither of these designs incorporates the venting orifice into the fluid dispensing opening in the spout. U.S. Pat. Nos. 4,186,882 and 5,657,909 connects floating vents to nozzles that atomize fluids. Both designs require the application of force to mix fluid with air in order to spray a mist of fluid. The use of a floating vent to atomize fluid significantly differs from my invention that focuses on a method to safely dispense fluid into a receiving container.

### BRIEF SUMMARY OF THE INVENTION

The purpose of my invention is to develop a safe, efficient and convenient means to transfer fluid from a hand held dispensing container into a secondary-receiving container. It is equally important to achieve these goals with a fluid dispensing system that is cost competitive to manufacture. All of this is accomplished through combining a fluid dispensing spout with a flexible hose that has a float attached at one end. The hose extends from the top of the spout and has sufficient length for the float to reach all space within the dispensing container. The opening in the spout that dispenses fluid is also the orifice that allows air to enter the container. This innovation combined with a minimum spout length of 3 inches and a spout diameter sized to accommodate fluid viscosity result in an anti-spill and self-venting fluid-dispensing spout. My invention is unique because it achieves the above-described results through manipulating the laws of physics and dose not involve the function of mechanical valves.

### BRIEF DESCRIPTION OF THE DRAWINGS

FIG. 1 illustrates the self-venting feature of the invention.

FIG. 2 illustrates the anti-spill feature that occurs when the spout end becomes immersed in fluid.

FIG. 3 illustrates the continuation of the anti-spill feature when the spout is removed from a filled receiving container.

FIG. 4 illustrates the onset of events that occur after the container is returned to an upright position.

FIG. 5 illustrates the presence of fluid that remains in the venting system after the container is returned to the upright position.

FIG. 6 illustrates the momentary delay in fluid flow that occurs when the container is returned to the dispensing position.

FIG. 7 illustrates the final progression of events and the return of unobstructed fluid flow.

### DESCRIPTION

My invention provides a flexible means to establish an airway between the end of a fluid dispensing spout and the air pocket within the dispensing container (see FIG. 1). The invention consists of a flexible hose (2) with a float (3) attached at one end. The opposite end of the hose extends to the top of the spout (1). The spout illustrated in the drawing represents one possible shape. The components of the floating vent can by tailored to accommodate a wide range of spout designs including those that are permanently molded into the container.

The floating vent system improves the efficiency of fluid dispensing. Through eliminating a separate venting orifice, the user is only required to open the spout. As the container is tilted, the float (3) moves on the surface of the fluid (5) keeping the end of the hose (2) in the air pocket within the container (4). Fluid is directed out through the spout while air is drawn into the flexible venting hose and directly into the air pocket. This allows for the air pressure within the container to equalize with air pressure outside the container resulting in the even flow of fluid through the spout.

The floating vent system improves the safety of fluid dispensing. Through eliminating a stationary venting orifice, the user doesn't have to worry about spillage occurring through the vent. Regardless of fluid level or container tilt, the float always seeks the fluid surface resulting in the venting hose following the air pocket. Regardless of how extreme the user tilts the container, fluid can only exit through the spout.

The anti-spill feature is achieved through manipulating the laws of physics. My invention builds on the fact that depth and not volume determine pressure exerted by a column of fluid. Regardless of container volume, fluid pressure is equal if measured at equal depths.

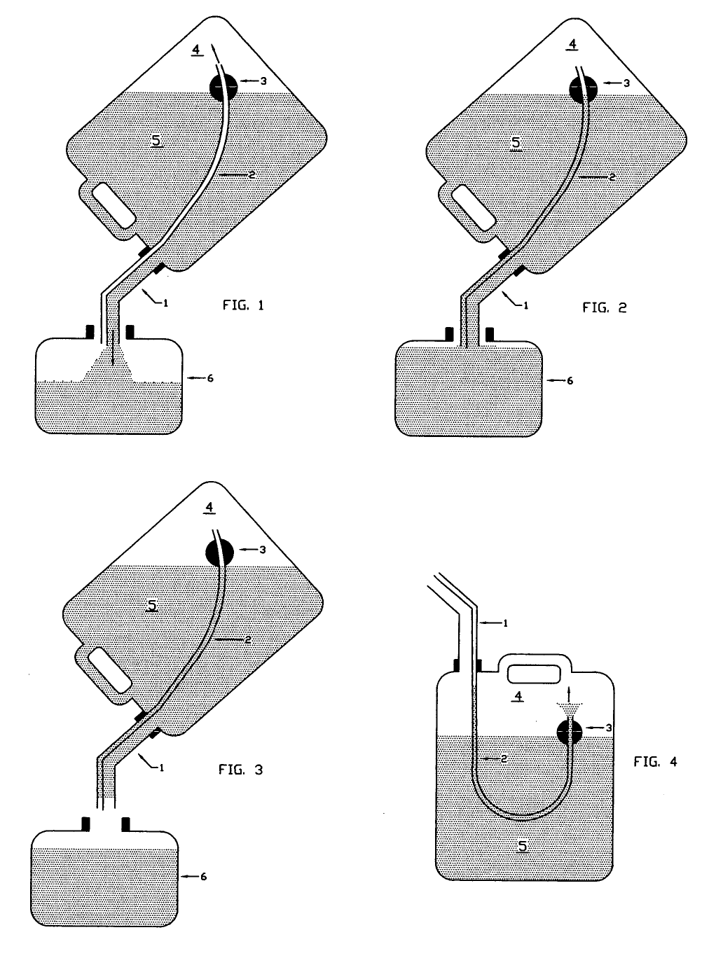

The same principles apply to the floating vent system (see FIG. 2). When the vent tube floats (3) on the surface of the fluid within the dispensing container, it establishes an airway that adjusts to the fluid depth. The tube also serves a secondary purpose, it is capable of containing fluid. As a fluid container, the vent tube (2) is capable of holding a depth of fluid that is equal to that contained within the dispensing container. This is achieved because the float constantly maintains the tube at a height greater than the fluid depth within the dispensing container. Regardless of container tilt or fluid volume, the floating tube is constantly maintaining the ability to hold the same depth of fluid as that within the dispensing container.

The anti-spill feature occurs when the dispensing end of the spout (1) becomes immersed in fluid (5). As fluid is discharging into a receiving container (6), air is being drawn into the venting tube (2) causing a vacuum (4). This vacuum has a direct correlation to the fluid pressure that is exiting the spout. As positive fluid pressure exits the spout an equal value of negative air pressure enters the venting tube. This pressure is determined by fluid depth as measured from the spout end and the fluid surface within the dispensing container. When the receiving container becomes full, the spout end becomes immersed. This causes the vacuum within the venting tube (2) to draw in fluid instead of air. When the venting tube fills with fluid equal to the depth that is within the dispensing container, the fluid pressure exiting the spout becomes equal with the fluid pressure in the venting tube. When this occurs the air pocket (4) within the dispensing container stabilizes at a vacuum pressure equal to the fluid pressure in the spout and vent tube. When these three pressures equalize, the flow of fluid from the dispensing container is interrupted. This prevents overfilling of the receiving container.

When the pressures are equal, fluid discharge will remain interrupted until an occurrence causes the pressures to become unbalanced. This allows for the development of a spout that maintains interrupted flow after it is removed from a filled receiving container (see FIG. 3). In order to achieve this result, the spout length and diameter must be sized based on the viscosity of the fluid that is being discharged. As the dispensing container is returned to an upright position, the fluid filled spout becomes horizontal in relationship to gravity. Maintaining interrupted discharge during this process is dependent on the fluid maintaining contact with the interior walls of the spout. If gravity causes the fluid to slump inside the spout, air can enter the container causing fluid discharge. High viscosity fluids such as motor oils have an increased ability to maintain the interior spout shape as compared to low viscosity fluids such as gasoline. As a result, larger spout diameters can be used to dispense higher viscosity fluids while maintaining the enhanced anti-spill feature. Regardless of fluid viscosity, a minimum spout length of 3 inches is necessary to maintain interrupted fluid flow after the spout is removed from a filled receiving container.

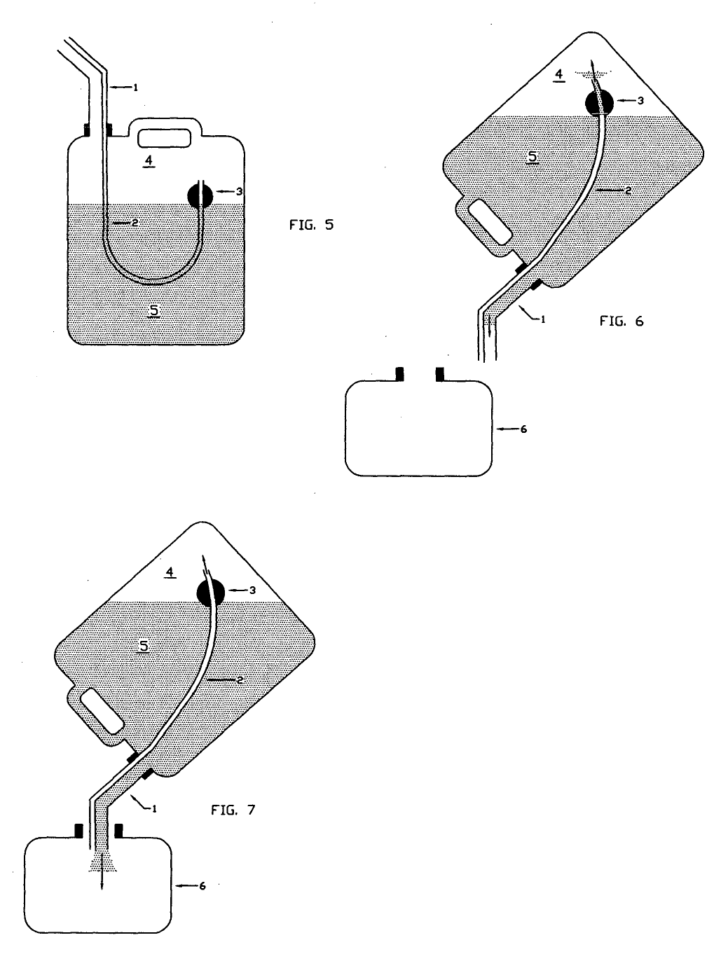

With a spout of proper diameter and length, the anti-spill feature is maintained after the spout is removed from a filled receiving container (see FIG. 3). Fluid flow remains interrupted until an occurrence causes the balanced pressures between the air pocket (4) and fluid pressure (5) to become unbalanced. This occurs when the container is returned to an upright position (see FIG. 4). During the dispensing process, the spout end is the lowest gravitational point. When the container is returned to an upright position, the spout end is the highest gravitational point. This causes the fluid in the spout (1) and vent (2) to flow back into the container. The air-pocket (4) in the container equalizes with the ambient air pressure outside the container. At this point, a portion of the vent tube continues to be lower than the fluid surface in the container (see FIG. 5). This results in the vent tube (2) continuing to hold a small volume of fluid. When the container is again tilted to dispense fluid (see FIG. 6), the small volume of fluid remaining in the vent tube is of less depth than the fluid in the container. The discharging fluid causes sufficient vacuum pressure in the air pocket (4) to draw the remaining fluid in the venting tube (2) back into the container. This causes a temporary delay before unobstructed flow is reestablished.

This delay in fluid flow is a favorable feature of fluid dispensing spouts. With other spout designs, fluid flow begins immediately after the container is tilted. When the user tilts the container to insert the spout into the receiving container, discharge can begin prior to the point when the spout is inserted into the container. My invention provides a momentary delay in fluid flow to prevent spillage while inserting the spout into a receiving container (see FIG. 7). Unobstructed fluid flow through the spout (1) will not resume until an unobstructed airway is reestablished between the air pocket (4) and air pressure out side the dispensing container.

It is obvious through the above description and attached illustrations of the invention that a wide range of modifications can be made to the design without departing from the novel concept and true spirit of the floating vent fluid dispensing spout.

What I claim as my invention is:

1. A spout that affixes to or is formed into the body of a fluid dispensing container, with a minimum length of 3 inches that incorporates the combination of a flexible tube and float as a method to establish an air pathway from the top of the spout, through the spout body and extending into the air pocket within the container.

2. A spout as set fourth in claim 1, wherein the combination of components function as a method to harness air vacuum within the container, that is generated by fluid discharging from the spout, to draw fluid into the floating venting tube as a means to inhibit fluid discharge through the spout.
